(19) United States
(12) Patent Application Publication
(10) Pub. No.: US 2019/0250098 A1
(43) Pub. Date: Aug. 15, 2019

(54) SI-AL RATIO IN ZEOLITE USING FT-IR AND CHEMOMETRICS

(71) Applicant: Saudi Arabian Oil Company, Dhahran (SA)

(72) Inventors: Tulay Inan, Dhahran (SA); Husinsyah Sitepu, Dhahran (SA); Rasha A. Al-Ghamdi, Dhahran (SA); Abdullah Al-Dakheel, Qasim (SA); Amer Al-Tuwailib, Qatif (SA)

(73) Assignee: Saudi Arabian Oil Company, Dhahran (SA)

(21) Appl. No.: 15/894,447

(22) Filed: Feb. 12, 2018

(51) Int. Cl. G01N 21/3563; C01B 39/24; G01N 23/207; G01N 21/25

(52) U.S. Cl. CPC G01N 21/3563; C01B 39/24; G01N 23/207; G01N 2021/3595; C01P 2002/82; C01P 2002/76; C01P 2002/88; G01N 21/255

(57) ABSTRACT

To determine Si/Al ratio in zeolite samples, a Si/Al ratio of a first physical zeolite Y sample is determined. A computational zeolite Y sample having properties substantially similar to properties of the first physical sample is generated. The computational zeolite Y sample is associated with properties including a computational Si/Al ratio and computational FT-IR spectra. A calibration model that maps Si/Al ratios of the computational zeolite Y sample to FT-IR spectra of the computational zeolite Y sample based on the Si/Al ratio of the first physical zeolite Y sample and the FT-IR spectra of the first physical zeolite Y sample is generated. FT-IR spectra of a second physical zeolite Y sample is determined. A Si/Al ratio of the second physical zeolite Y sample is determined using the calibration model and the FT-IR spectra of the second physical zeolite Y sample.

### TECHNICAL FIELD

This disclosure relates to analyzing composition of minerals, for example, minerals used in hydrocarbon refining, such as zeolite.

### BACKGROUND

In general, zeolites are used in different industrial applications as molecular sieve, adsorption, radioactive recovery or ion exchange, separation materials. In the oil and gas industry, in particular, Faujasite type zeolites (for example, X, Y and USY type zeolites) are used mainly as catalysts in fluid catalytic cracking to convert high-boiling fractions of petroleum crude to more valuable gasoline, diesel and other products. Zeolite Y is also used in the hydrocracking units as a platinum or palladium support to increase aromatic content of reformulated refinery products. Zeolite X can be used to selectively adsorb carbon dioxide (CO₂) from gas streams and is used in the pre-purification of air for industrial air separation.

The variation of the Si/Al ratio in the zeolite framework changes the hydrophilic or hydrophobic character of the zeolite, which, in turn, determines the zeolite's sorptive and catalytic properties. Certain methods employed to determine the Si/Al ratio include Inductively Coupled Plasma (ICP) and Atomic Adsorption (AA). Zeolite Y, in some instances, is preferred over zeolite X due to higher activity and stability at higher temperatures because zeolite Y has higher Silica-Aluminum (Si/Al) ratio compared to zeolite X.

### SUMMARY

This disclosure describes determining Si/Al ratio in zeolite using Fourier Transform Infrared (FT-IR) spectroscopy and chemometrics.

Certain aspects of the subject matter described here can be implemented as a method. FT-IR spectra of a first physical zeolite Y sample is determined. A Si/Al ratio of the first physical zeolite Y sample is determined. A computational zeolite Y sample having properties substantially similar to properties of the first physical zeolite Y sample is generated by one or more processors of a computer system. For example, a variation in numerical values of the properties of the computational zeolite Y and the first physical zeolite Y sample can be less than or equal to 5%. The computational zeolite Y sample is associated with properties including a computational Si/Al ratio and computational FT-IR spectra. A calibration model that maps Si/Al ratios of the computational zeolite Y sample to FT-IR spectra of the computational zeolite Y sample based on the Si/Al ratio of the first physical zeolite Y sample and the FT-IR spectra of the first physical zeolite Y sample is generated by the one or more processors. A second physical zeolite Y sample that is different from the first physical zeolite Y sample is received. FT-IR spectra of the second physical zeolite Y sample is determined. A Si/Al ratio of the second physical zeolite Y sample is determined using the calibration model and the FT-IR spectra of the second physical zeolite Y sample.

This, and other aspects, can include one or more of the following features. The FT-IR spectra of the first physical zeolite Y sample can be determined with a spectrophotometer with deuterated triglycine sulfate (DTGS) detector with an average of 128 scans at a resolution of 4 cm⁻¹. The Si/Al ratio of the first physical zeolite Y sample can be determined by X-Ray Diffraction. To generate the calibration model, statistical correlations between the FT-IR spectra and the Si/Al ratio of the first physical zeolite Y sample can be determined and associated to the computational zeolite Y sample.

Certain aspects of the subject matter described here can be implemented as a method. FT-IR spectra of each of multiple first physical zeolite samples are determined. Si/Al ratios of each of the multiple physical zeolite samples are determined. A calibration model that maps Si/Al ratio of multiple computational zeolite samples to FT-IR spectra of multiple computational zeolite samples is generated by one or more processors of a computer system. The calibration model is validated using the FT-IR spectra of each of the multiple first physical zeolite samples and the Si/Al ratio of each of the multiple first physical zeolite samples. A second physical zeolite sample separate from the first physical zeolite sample is received. FT-IR spectra of the second physical zeolite sample is determined. A Si/Al ratio of the second physical zeolite sample is determined using the calibration model and the FT-IR spectra of the second physical zeolite sample.

This, and other aspects, can include one or more of the following features. Each zeolite sample can be a Faujasite-type zeolite sample. Each zeolite sample can be a zeolite Y sample. The FT-IR spectra of each physical zeolite sample can be determined with a spectrophotometer with deuterated triglycine sulfate (DTGS) detector with an average of 128 scans at a resolution of 4 inverse centimeter (cm⁻¹). The Si/Al ratio of each physical zeolite sample can be determined by a method approved by the American Society for Testing and Materials (ASTM). The ASTM approved method can include X-Ray Diffraction.

Certain aspects of the subject matter described here can be implemented as a system. The system includes an X-Ray Diffraction instrument configured to determine a silicon-aluminum ratio in a zeolite sample. The system includes a spectrophotometer configured to determine a Fourier Transform Infrared (FT-IR) spectra of the zeolite sample. The system includes a computer system that includes one or more processors and a computer-readable medium storing instructions executable by the one or more processors to perform operations that include those described here.

This, and other aspects, can include one or more of the following features. The spectrophotometer can determine FT-IR spectra of a second physical zeolite sample separate from the plurality of first physical zeolite samples. The operations can include determining a Si/Al ratio of the second physical zeolite sample using the calibration model and the FT-IR spectra of the second physical zeolite sample.

The details of one or more implementations of the subject matter described in this specification are set forth in the accompanying drawings and the description that follows. Other features, aspects, and advantages of the subject matter will become apparent from the description, the drawings, and the claims.

### BRIEF DESCRIPTION OF THE DRAWINGS

FIG. 1 is a flow chart of an example of a method for determining a silicon/aluminum ratio of zeolite.

FIG. 2 is a graph that shows the infrared spectra of various samples of zeolite.

FIG. 3 is a graph that shows the infrared spectra of various samples of zeolite.

FIGS. 4A, 4B, 4C, and 4D are graphs that show calculated and measured X-Ray diffraction patterns of various zeolites.

FIG. 5A is a graph that shows calculated and actual silicon/aluminum ratios of zeolite after calibration.

FIG. 5B is a graph that shows the difference between calculated and actual silicon/aluminum ratios of zeolite after calibration.

FIG. 6A is a graph that shows calculated and actual silicon/aluminum ratios of zeolite after cross-validation.

FIG. 6B is a graph that shows the difference between calculated and actual silicon/aluminum ratios of zeolite after cross-validation.

FIG. 7 is a graph of lowest predicted residual sum of squares (PRESS) of the root mean square error of the calculated silicon/aluminum ratios from cross-validation.

FIG. 8 is a graph of outliers for the silicon/aluminum ratios of zeolite.

FIG. 9 is a graph that shows the principle component spectra for the silicon/aluminum ratio of zeolite.

FIG. 10 is a graph that shows the statistical spectra for the silicon/aluminum ratio of zeolite.

FIGS. 11A, 11B, 11C, 11D, 11E, 11F, 11G, 11H, 11I, and 11J are graphs that show quantification results of samples of zeolite with various silicon/aluminum ratios.

FIG. 12 is a thermogram from thermogravimetric analysis (TGA) for various samples of zeolite.

FIGS. 13A, 13B, 13C, 13D, 13E, 13F, 13G and 13H are graphs that show quantification results of samples of zeolite with various silicon/aluminum ratios.

Like reference numbers and designations in the various drawings indicate like elements.

### DETAILED DESCRIPTION

Fourier Transform Infrared (FT-IR) spectroscopy is a non-destructive, rapid and easy analytical method which is based on the measurement of characteristic fundamental resonances. FT-IR spectroscopy produces specific, usually sharp, well-defined peaks at increased extinction coefficients. FT-IR spectra are generally obtained at wavelengths between 2.5 and 25 micrometers (μm), corresponding to the 4000-400 inverse centimeter (cm⁻¹) wavenumber region to determine the Si/Al ratio of zeolites, for example, Faujasite-type zeolites. Faujasite is a mineral group in the zeolite family of silicate minerals. The group consists of Faujasite-sodium (Na), Faujasite-Magnesium (Mg) and Faujasite-Calcium (Ca), each sharing the same basic formula: (Na₂,Ca,Mg)_{3.5}[Al₇Si₁₇O₄₈].32(H₂O) by varying the amounts of sodium, magnesium and calcium. It occurs as a rare mineral in several locations worldwide and is synthesized industrially from alumina sources such as sodium aluminate and silica sources such as sodium silicate. Other alumino-silicates such as kaolin are used as well. The ingredients are dissolved in a basic environment such as sodium hydroxide aqueous solution and crystallized at 70° C. to 300° C. (for example, at 100° C.). After crystallization the faujasite is in its sodium form and ion-exchanged with ammonium to improve stability. The ammonium ion is removed later by calcination which renders the zeolite in its acid form. Depending on the Si/Al ratio of their framework, synthetic Faujasite zeolites are divided into X and Y zeolites. In X zeolites, the Si/Al ratio is between 2 and 3; in Y Zeolites, the ratio is 3 or greater. The negative charges of the framework are balanced by the positive charges of cations in non-framework positions. Such zeolites have ion-exchange, catalytic and adsorptive properties. The stability of the zeolite increases with the Si/Al ratio of the framework, and is also affected by the type and amount of cations located in non-framework positions. For catalytic cracking, the Y zeolite is often used in a rare earth-hydrogen exchanged form. By using thermal, hydrothermal or chemical methods, some of the alumina can be removed from the zeolite Y framework, resulting in high-silica zeolite Y. Such zeolites are used as cracking and hydrocracking catalysts. Complete dealumination results in Faujasite-silica.

The zeolites described in this disclosure were obtained from Zeolyst (located in Conshohocken, Pa., USA). Different types of zeolites (for example, zeolite Y, zeolite ZSM-5, Mordenite or similar types of zeolite) have different Si/Al ratios. The Si/Al ratio range for zeolite Y and ZSM-5 is large, for example, between 1 to 3000. Zeolite samples with Si/Al ratio in the range of 5 to 80 were used in this disclosure. The techniques described in this disclosure can also be used after dealumination or desilication treatments to get rapid results.

To develop FT-IR spectroscopic correlations for Si/Al ratio and other physical/indicative properties, properties of a first zeolite can be measured by certain techniques and the first zeolite properties can then be used as a reference when comparing to FT-IR spectral intensities obtained from the first zeolite. The techniques described here can be used to determine, for example, predictively determine, properties of a zeolite including, for example, Si/Al ratio, weight losses at certain temperatures, unit cell size, peak shifts from FTIR (for example, W_{DR}, W_{TOT}), crystallographic data from X-Ray Diffraction (XRD), acidity and other properties of the zeolite. W_{DR} and W_{TOT} are the two different wavelength positions in FT-IR for Zeolite Y. Zeolites are crystalline aluminosilicate materials which possess 3-dimensionally connected framework structures constructed from corner-sharing TO₄ tetrahedra, where T is any tetrahedrally coordinated cation such as Si and Al. The positions of the asymmetrical T-O-T (metal-O-metal) vibration (W_{TOT}, T=Si, Al)/Si-O-stretching at 960-1055 cm⁻¹, the zeolite specific double ring mode (W_{DR}/Si—O—Al bending at 480-700 cm⁻¹, and symmetrical stretching vibrations of Si(Al)—O bonds can be found in the wavenumber region 610-840 cm⁻¹. The libration bands of the water molecule around the a and c axes of this molecule lie at 480-620 cm⁻¹. The bending vibration of the tetrahedral bonds O—Si(Al)—O corresponds to bands at a wavenumber in the range of 410-435 cm⁻¹.

This disclosure covers results from FT-IR spectroscopic investigations, X-Ray spectroscopic investigations, thermo-gravimetric analysis investigations, unit cell size and wet chemical analysis results of Si/Al ratio for the determination of the Si/Al ratio and other properties of zeolites with cation type of ammonium and hydrogen.

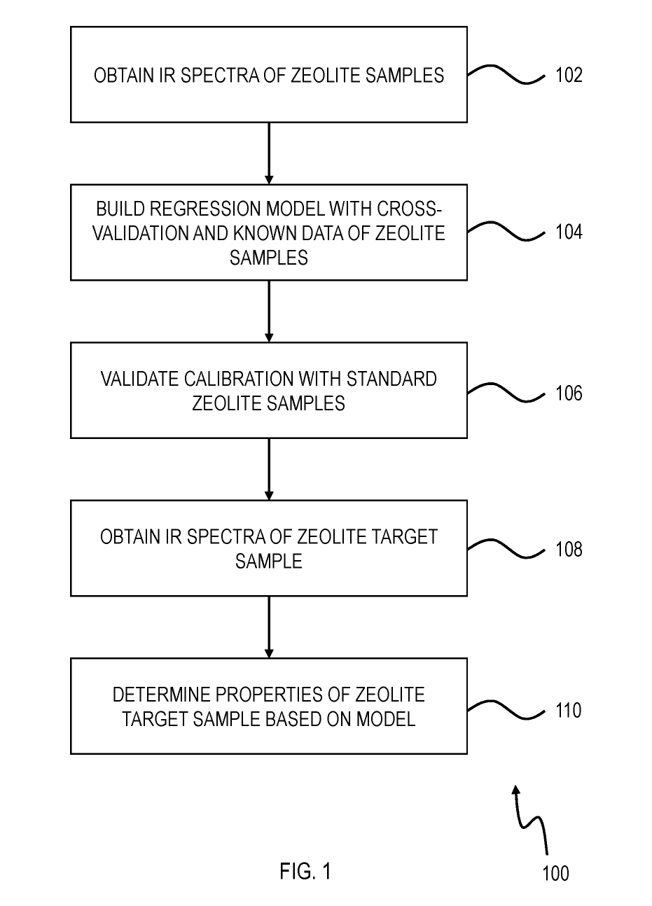

FIG. 1 is a flow chart of an example of a method 100 for determining a silicon/aluminum ratio of zeolite. In some implementations, at 102, zeolite samples were obtained and analyzed according to methods approved by the American Society for Testing and Materials (ASTM). The methods include, for example, inductively coupled plasma-optical emission spectroscopy (ICP-OES) following either a digestion or a fusion preparation, inductively coupled plasma-atomic emission (ICP-AES) spectroscopy, X-Ray Fluorescence (XRF), or Atomic Absorption (AA), to name a few. Table 1 shows the results of analyzing zeolites according to the ASTM-approved methods.

TABLE 1
Results of wet chemical analysis, selected IR peak maxima and lattice constants of
Zeolite Y samples.

| | | | | | | Unit Cell | | |
|---|---|---|---|---|---|---|---|---|
| | | | | | | Size | Weight | Weight |
| | | | W_{DR} | W_{TOT} | | (Angstrom, | loss | loss |
| Zeolite Y | Si/Al | x | (cm⁻¹) | (cm⁻¹) | a (nm) | Å) | @300° C. | @600° C. |
| 1 | 5.2 | 0.161 | 587.9 | 1051.7 | 2.4354203 | 24.53 | 20.73 | 23.30 |
| 2 | 12 | 0.077 | 608.3 | 1074.3 | 2.4337061 | 24.35 | 14.63 | 16.09 |
| 3 | 30 | 0.032 | 608.6 | 1075.4 | 2.4310062 | 24.28 | 12.54 | 13.71 |
| 4 | 60 | 0.016 | 611.1 | 1079.1 | 2.4266729 | 24.24 | 11.79 | 12.81 |
| 5 | 80 | 0.012 | 612 | 1081.7 | 2.4229216 | 24.24 | 10.38 | 11.48 |

The data in Table 1 was generated by OP861-12/Elemental Composition of Zeolites by ICP-OES, a commonly used wet method for sample preparation with quantification by Atomic Absorption and fluorescence spectroscopy (XRF)/ASTM 618. As indicated in column 2 of Table 1, the 5 zeolite Y samples had five different Si/Al ratios. These rations are found in commonly used zeolites in oil and gas industry. Column 3 (“x”) shows the molar fraction of Alumina determined using Equation (1):

Si/Al=(1−x)/x OR x=1/[(Si/Al)+1] (1)

Column 6 (“a”) shows the lattice constants of samples in nanometers. Weight loss values are shown in weight percentage. The starting weight amounts may change depending on the method used.

At 104, the resulting data was used to establish calibration models, described later. The FT-IR spectrum was collected for each zeolite sample. At 106, the calibration models were validated with zeolite samples tested using the ASTM techniques. To do so, for example, the FT-IR spectrum was correlated with the corresponding selected zeolite property, which as determined using the ASTM methods. Also, at 108, FT-IR spectra of the zeolite samples were obtained. In addition, for example, peak shift values of the FT-IR spectra were taken at certain regions of the obtained spectra of zeolite, unit cell sizes and XRD data. Results of the calibration sets can then be cross-validated which combines measures of fit (for example, average measures of prediction error) to correct for any training error and derive an estimate of model prediction performance, more accurate than an estimate obtained using traditional techniques, to assess the capability of the model to fit the calibration data. To calculate the deviation of the model, several statistical techniques, for example, root mean square error of the calibration (RMSEC), root mean square error of cross-validation (RMSECV) and root mean square error of prediction (RMSEP), can be used. At 110, these values were used as input data to determine properties of the zeolite target sample. Details of each step of FIG. 1 are described later with reference to figures that follow.

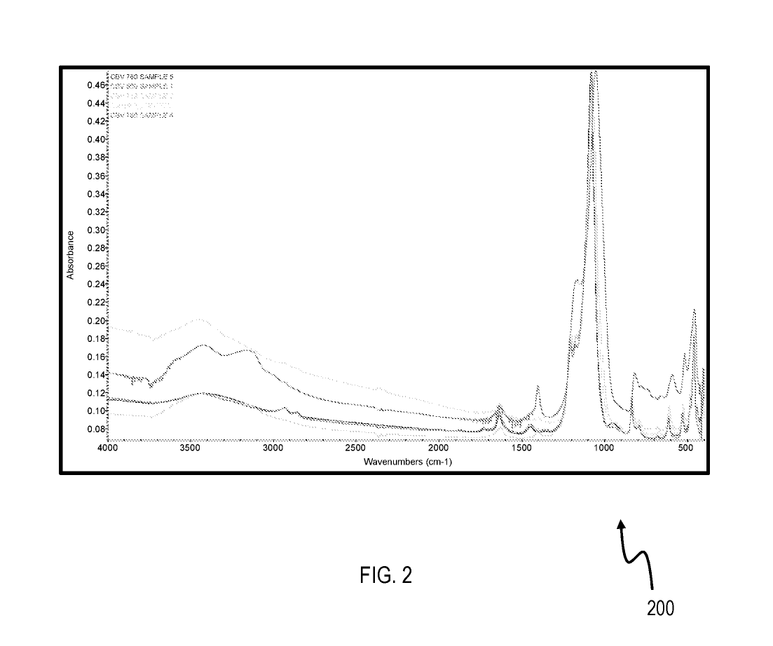

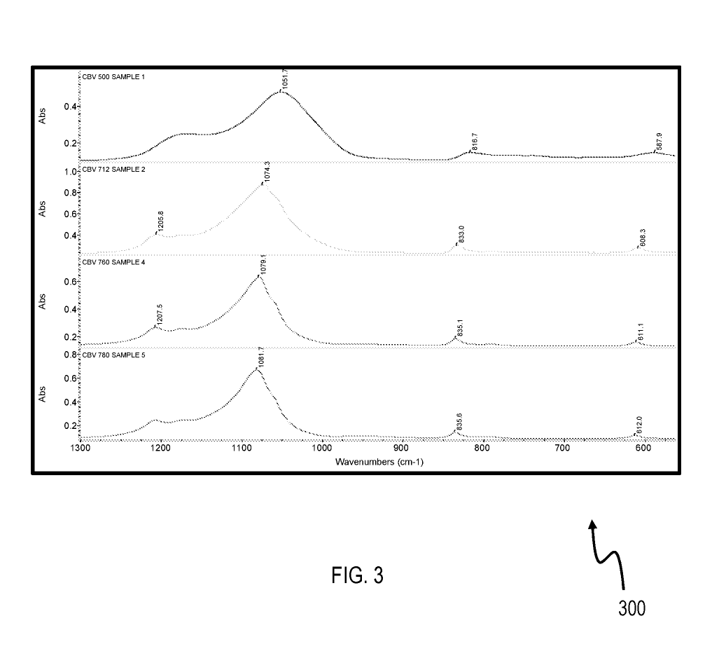

FIGS. 2 and 3 show graph 200 and graph 300, respectively, each showing the infrared spectra of various samples of zeolite. The FT-IR spectra can be obtained using a FT-IR spectrophotometer. For example, the spectroscopic data of the zeolite Y samples referenced in Table 1 were obtained using a Nicolet 8700 FT-IR spectrophotometer equipped with deuterated triglycine sulfate (DTGS) detector with an average of 128 scans at a resolution of 4 cm⁻¹. Diffuse Reflectance Fourier Transform Spectroscopy (DRIFT) accessory can also be used instead of making KBr tablets (KBr table: 0.6 mg-1 milligram (mg) sample per 200 mg KBr).

Potassium Bromide (KBr) tablet is a commonly used sample preparation method to collect FT-IR spectrum. KBr tables are prepared by adding about 1 mg to 2 mg of zeolite sample in about 200 mg of KBr salt, grinding the KBr and zeolite to obtain a homogeneous mixture, and then applying pressure to obtain tablets/wafers that can be used to collect the IR spectra. KBr does not absorb IR radiation and consequently does not affect the results. KBr tablets allow using sample quantities of sample and take a short amount of time (for example, 5 minutes) to prepare.

DRIFT accessory is the accessory to collect the FT-IR spectrum of the solid samples. Using DRIFT, the sample can be placed in a cup with little or no need for sample preparation. DRIFT accessory also negates the need for KBr tablets. The DRIFT accessory aids in the reflection and operates by directing the IR energy into a sample cup filled with a mixture of the sample and an IR transparent matrix (such as KBr). The IR radiation interacts with the particles and then reflects off their surfaces, causing the light to diffuse, or scatter, as it moves throughout the sample. The output mirror then directs this scattered energy to the detector in the spectrometer. The detector records the altered IR beam as an interferogram signal which can be used to generate a spectrum. Each spectrum was truncated to the wave number region of 4000-406 cm⁻¹. All spectral regions were included in building the calibration models. Plot 200 (FIG. 2) shows a spectra of zeolite Y samples obtained in the range of 4000 to 650 cm⁻¹. Plot 300 (FIG. 3) shows a spectra of zeolite Y samples obtained in the range of 1300 to 650 cm⁻¹. Double six ring mode (W_{DR}) is shown in FIG. 2 and FIG. 3. The Double Six Ring mode represents the positions of the asymmetrical TOT vibration (W_{TOT})(T=Si,Al/Si—O-stretching at 960-1055 cm⁻¹) and the zeolite specific double ring mode (W_{DR}/Si—O—Al bending at 480-700 cm⁻¹).

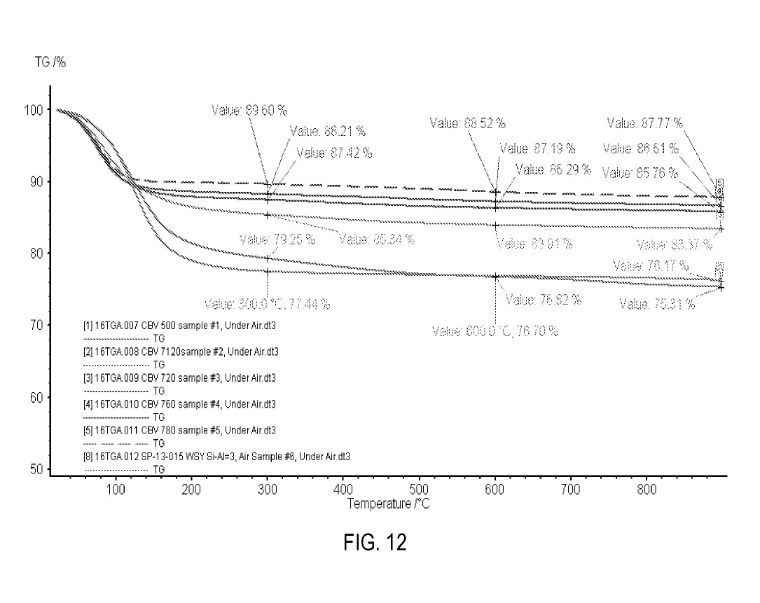

Techniques to build the regression models are described here. Initially, thermo-gravimetric analysis of the zeolite Y samples was performed. To do so, for example, thermo-gravimetric analysis was performed using NETZCH® TG 209 F1 (offered by Netzch Pumps, United Kingdom) to determine the removal rate of water and template content of the zeolites. FIG. 12 is a thermogram from thermo-gravimetric analysis (TGA) and derivative thermo-gravimetric (DTG) for various samples of zeolite. The observed exotherms are due to the decomposition of the cations trapped in the channels of zeolite Y. Water loss and loss of template obtained in the temperature range of 20° C.-600° C. using TGA. Dehydration occurred at less than 300° C. The weight loss in the temperage ranges of 20° C.-600° C. with a broad peak in the thermogram is likely due to water loss and was found decreasing with increasing Si/Al ratio. Also, acidity of the zeolite decreases with increasing Si/Al ratio increasing its hydrophobic nature. Consequently, less water is present in the zeolite with low aluminum content. The weight loss in the temperature range of 300° C.-600° C. can be attributed to cation and increase with increasing Si/Al ratio of the zeolites. The thermo-gravimetric analysis is used to generate the regression models by extracting TGA percentage weight loss from the TGA and using these values as input data for correlation with FT-IR spectra results.

Also, XRD data of the zeolite Y samples were obtained. For example, XRD data of the five zeolite Y samples were measured using the ULTIMA-IV Rigaku high-resolution X-Ray diffractometer with a copper X-Ray tube. To do so, the zeolite Y samples were manually ground in an agate mortar and a pestle for several minutes into fine particles. The fine particles were then mounted into the XRD sample holder by front pressing. The specimen holder was rectangular with a dimension of 22 millimeters (mm)×22 mm. Step-scanned patterns were measured with the X-Ray diffractometer at a wavelength of 1.506 angstrom (Å). A monochromotor and a proportional detector were used in conjunction with a 0.67° divergence slit, a 0.67° scattering slit and a 0.3 mm receiving slit at instrument settings of 40 kilovolts (kV) and 40 milli-amperes (mA). The measuring circle diameter of the optics was 480 mm. The XRD data were measured from 2° to 50° in 2θ Bragg-angle using a step size of 0.04° and a counting time of 1° per minute.

The XRD data was then refined by an advantaged General Structure Analysis System (GSAS) Rietveld software with March model for preferred orientation correction. The structural model of the zeolite Y single-crystal XRD included phase scale factors and the background component of the patterns with an eight-parameter Chebychev polynomial, lattice parameters, instrument zero-point 2θ₀ (off-set in the 2θ scale of goniometer), the Lorentzian and the Gaussian terms of a pseudo-Voigt profile function and anisotropic strain parameters, structural parameters and isotropic thermal parameters. After the preliminary refinement without preferred orientation correction had converged, the March model was included. The default sample texture symmetry was chosen to be cylindrical or fiber texture.

Rietveld refinement or Rietveld Analysis, which is an advanced X-ray crystallography technique described by Hugo Rietveld for use in the characterization of powder X-ray diffraction, synchrotron diffraction, and neutron diffraction data of crystalline materials, has been implemented into many Rietveld software such as BGMN, DBWS, FULLPROF, GSAS, LHPM, MAUD, and NXD programs. The powder X-ray diffraction (XRD) data of crystalline materials results in a pattern characterized by peaks in intensity at certain 2θ-Bragg angle positions. The height, width and position of these peaks can be used to determine many aspects of the material's structure such as (i) crystallographic preferred orientation or texture, which is a common feature of experimental powder patters, using the March model, (ii) crystallite size and microstrain, (iii) quantitative phase analysis of the identified phases, to name a few. The Rietveld method uses a least squares approach to refine a theoretical line profile until it matches the measured profile. The introduction of this technique was a significant step forward in the diffraction analysis of powder samples as, unlike other techniques at that time, it was able to deal reliably with strongly overlapping reflections. The Rietveld method, which uses a least squares approach, was for the single-wavelength diffraction of monochromatic neutrons where the reflection-position is reported in terms of the Bragg angle 2θ. The method has been further developed to refine the powder X-ray diffraction data, synchrotron diffraction data, and time-of-flight neutron powder diffraction data. The crystal structure refinement results are accurate mainly because the Rietveld refinement adjusts the refinable parameters until the best fit of the entire calculated pattern to the entire measured pattern is achieved. Additionally, the refined atomic parameters should agree well with the structure derived from single-crystal X-ray diffraction data. In this disclosure, the refined parameters were the phase scale factors, the Chebychev polynomial background parameters, the lattice parameters, the instrument zero point, the atomic isotropic and anisotropic displacement coefficients, and the Lorentzian and the Gaussian terms of a pseudo-Voigt profile function. After the preliminary refinement without preferred crystallographic correction (that is, randomly oriented) had converged, the March preferred crystallographic correction r-parameter was then included.

Table 2 depicts the unit-cell parameters of the CBV500, CBV712, CBV720, CBV760 and CBV780 (each being a name for a zeolite Y sample) Y-zeolite catalysts obtained from the Rietveld refinement with the March model. The number in parentheses gives the estimated standard uncertainty for the least significant figure of the parameter.

TABLE 2
Summary of cell parameters of CBV500, CBV712, CBV720, CBV760 and
CBV780 Zeolite Y catalysts obtained from Rietveld refinement with the
March model.

| | This Study | | | | |
|---|---|---|---|---|---|
| Parameters | CBV500 | CBV712 | CBV720 | CBV760 | CBV780 |
| a (Å) | 24.3420 (34) | 24.3371 (12) | 24.3101 (10) | 24.2667 (10) | 24.2292 (17) |
| b (Å) | 24.3420 (34) | 24.3371 (12) | 24.3101 (10) | 24.2667 (10) | 24.2292 (17) |
| c (Å) | 24.3420 (34) | 24.3371 (12) | 24.3101 (10) | 24.2667 (10) | 24.2292 (17) |
| α (°) | 90.0 | 90.0 | 90.0 | 90.0 | 90.0 |
| β (°) | 90.0 | 90.0 | 90.0 | 90.0 | 90.0 |
| γ (°) | 90.0 | 90.0 | 90.0 | 90.0 | 90.0 |
| V (Å)³ | 14423.44 (61) | 14414.7 (21) | 14366.7 (17) | 14290.1 (18) | 14223.9 (30) |

In Table 2, a, b, c, α, β, γ and V are the unit cell parameters of each zeolite sample calculated using Rietveld software using March model. Table 3 is a summary of the Rietveld refinement results for the CBV500, CBV712, CBV720, CBV760 and CBV780 Y-zeolite catalysts obtained from Rietveld refinement with the March model. The space group used was Fd-3m (No. 227). The Cell size in the formula is Z=1. For example, column 2 shows the unit cell parameters for Sample CBV 500 sample of Zeolite Y. The a, b, and c are the unit cell axes dimensions; and α, β, and γ are the inclination angles of the axes in the unit cell. Additionally, the Unit Cell Volume of the Isometric or Cubic Crystal System (a=b=c) is given by V=a³. In this disclosure, the cell parameters were obtained from the Rietveld refinement of the all powder X-ray diffraction data sets of zeolite-Y. The International Unit for the cell parameter is Angstroms or Å, where 1 Å=10⁻¹⁰ meter, and for volume is Å³.

TABLE 3
Summary of the Rietveld refinement results for the CBV500,
CBV712, CBV720, CBV760 and CBV780 Y-zeolite catalysts
obtained from Rietveld refinement with the March model

| | This Study | | | | |
|---|---|---|---|---|---|
| Parameters | CBV500 | CBV712 | CBV720 | CBV760 | CBV780 |
| R_{P} | 15.91 | 9.69 | 10.14 | 9.97 | 9.26 |
| R_{WP} | 20.21 | 11.92 | 12.93 | 12.58 | 11.58 |
| R (F²) | 25.67 | 28.02 | 29.05 | 30.93 | 29.49 |
| χ² | 6.074 | 2.141 | 2.301 | 2.199 | 1.84 |
| r | 1.134 (5) | 1.128 (8) | 1.123 (7) | 1.126 (8) | 1.129 (2) |

Building a calibration model to map Si/Al ratios to FT-IR spectra of known zeolite Y samples involves validating the calibration model using statistical techniques. Chemometrics can be employed for this purpose. Using the screening method of analysis, a property or group of properties in a zeolite Y sample can be determined with a minimum number of steps and the least manipulation of the sample. If there are many samples or small amounts of sample obtained in the field, FT-IR can be used to obtain results in minutes. Because with other methods (such as Inductively Coupled Plasma (ICP), XRD), many days or sometimes weeks are needed to get the results. Wet analysis method for precise results it takes time, requires the use of toxic chemicals, and uses larger amounts of sample compared to FT-IR chemometrics method. With the techniques disclosed in this disclosure, the Si/Al ratio be obtained but also can other properties such as acidity and cell parameters, to name a few. It depends on the uploaded data and can be improved to add new parameters to the same model as needed or as new samples are obtained.

Multivariate calibration is used by which the chemical information of the zeolite Y sample (for example, absorption, emission, transmission or similar chemical information) of a set of standard samples recorded at different variables (wavenumbers) are related to the concentration of the chemical compounds (for example, Si/Al ratios) in the sample. To perform the multivariate calibration, zeolite samples were obtained and analyzed according to the ASTM methods (ICP). The FT-IR spectrum was collected for each zeolite sample. Zeolite property values correlated with the corresponding spectra. Results of the calibration sets were then cross-validated. Some examples of multivariate methods include classical least squares (CLS), inverse least squares (ILS), principal-component regression (PCR), artificial neural network (ANN), partial least squares (PLS), and net-analytes signal (NAS). In this disclosure, PLS regression was used to correlate the spectroscopic data to the zeolite property values (Si/Al ratio, acidity, cell parameters, TGA behavior, to name a few). The PLS method creates a simplified representation of the spectroscopic data by a process known as spectral decomposition. The PLS algorithm initially calculates a property value (like Si/Al ratio, acidity, to name a few), or weighted average spectrum of all spectra of the zeolites in the calibration matrix. This statistical analysis requires calibration and validation. In the calibration procedure, the software searches for a relation between the dependent variable, Y (peak height), and the independent variable, X (property) which can be generically written as: Y=f(X1, X2, X3 . . . Xp). In practice, an algorithm, based on PLS, calculates the regression coefficients of the following equation: Y=b0+b1X1+b2X2+ . . . bpXp. This defines the mathematical model of the system under investigation. The second step is a so-called “leave-one-out” cross-validation procedure that is used to verify the calibration model. FTIR and multivariable calibration methods accuracy was established by evaluating Root Mean Square Error of Prediction (RMSEP), Root Mean Square Error of Calibration (RMSEC) and Correlation coefficient (R²); and after cross-validation, Root Mean Square Error of Cross Validated error of calibration (RMSECV) and the correlation coefficient (R²) added as statistical evaluation parameters.

Principal calibration analysis (PCA) method is used in the validation to retain all of the variables in the problem by extracting principal components (for example, latent variables). PCA is a statistical procedure which is sensitive to the relative scaling of the original variables. PCA is the simplest of the true eigenvector-based multivariate analyses. Often, its operation can be thought of as revealing the internal structure of the data in a way that explains the variance in the data. By using this method unknown samples behaviors or distribution (or both) in multivariate analysis can be observed. The latent variables are found by an iterative process and are mutually orthogonal, linear combination of all the original variables. The latent variables simultaneously describe the maximum predictive variance of a data set in one direction and provide maximal fit to facilitate the creation of a predictive calibration model without limiting the accuracy of the model. Through the use of PCA, outliers can be readily detected and eliminated during predictive calibration modeling. After latent variables from the PCA method are found, PLS was utilized to create the predictive calibration model that correlated the FT-IR data variables to the known quantities.

For example, a single, known variable (such as the Si/Al ratio) for a zeolite Y sample is represented as one matrix and digitized data from the FT-IR spectra is represented as a second matrix. The PLS method is used to correlate the two matrices to find values for the model coefficients to create a training data set without any knowledge of the particular equations needed to interpret the FTIR spectrum to obtain model coefficients since PLS uses all of the points of the FT-IR spectrum during model building. The training data set is then validated to provide a predictive data set for the predictive calibration. The PLS method employs cross-validation to select and delete one sample from the first sample set to be left out for prediction and reconstructs a new predictive calibration model with a new Si/Al ratio data set, a new free induction decay data set and a new principal component data set. The PLS method then predicts the Si/Al ratio of zeolite for the selected sample left out of the first sample set using the new predictive calibration model. Each of the samples of the first sample set are left out once for prediction with the process of constructing a new predictive calibration model repeated each time. The cross-validation ends with a comparison of the predicted Si/Al ratio of each of the selected samples of the first sample set with the measured values of each of the selected samples of the first sample set, the measured concentration having been obtained during the first step. If the difference between the predicted value and the measured value is less than the predetermined precision value of the measured value, then the training data set is validated. If the difference is higher than the precision value, then a new set of samples are obtained to re-start the process.

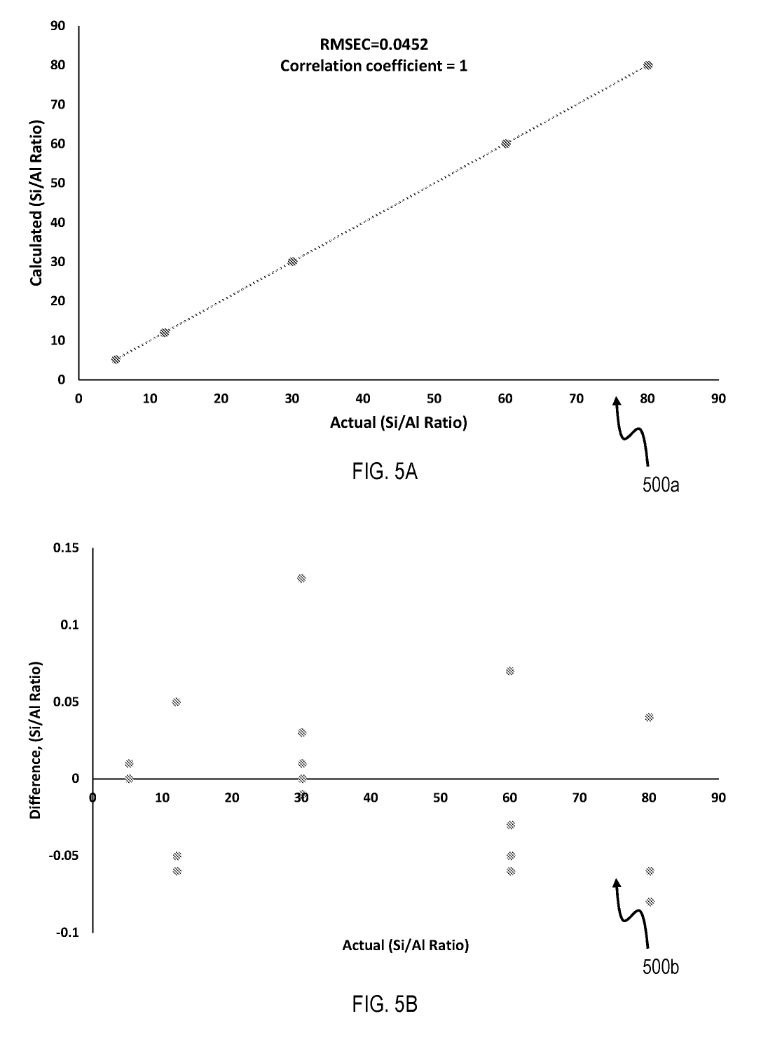

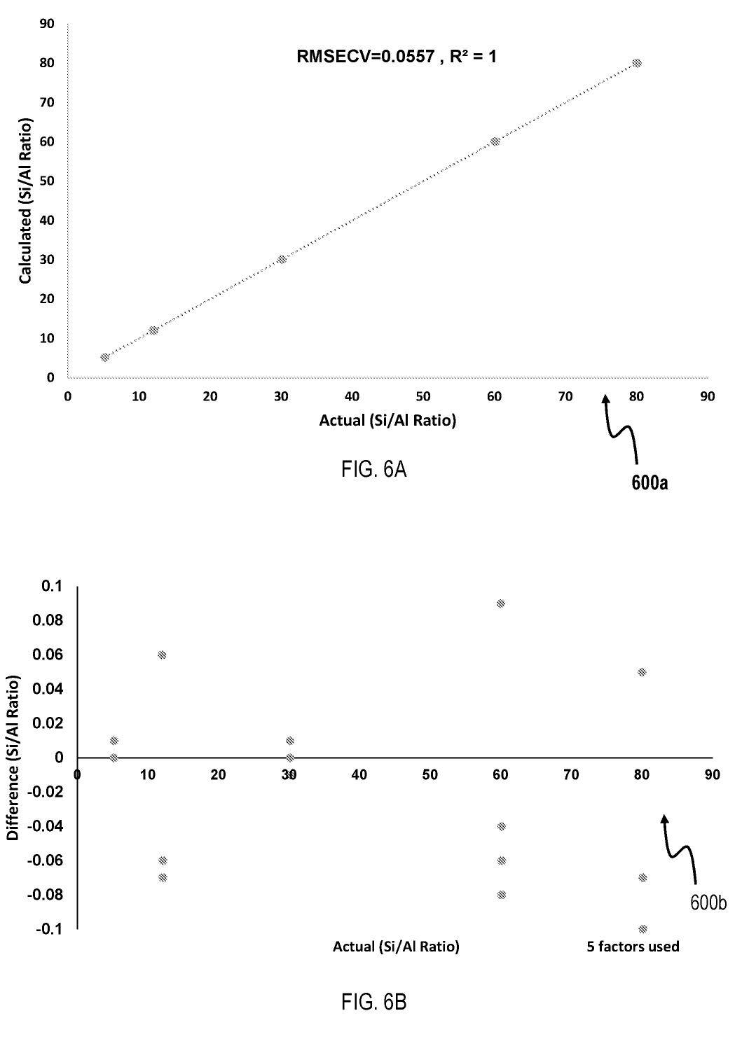

The validation FT-IR data set is then applied to the training data set to predict the Si/Al ratio in each of the samples of the second sample set. FIG. 5A is a graph 500a that shows calculated and actual silicon/aluminum ratios of zeolite after calibration. FIG. 5B is a graph 500b that shows the difference between calculated and actual silicon/aluminum ratios of zeolite after calibration. The graphs 500a and 500b show calibration results with RMSEP=0.0771 with factors and RMSEC=0.0452 and correlation coefficient=1 and with Performance Index (PI) value of 99.9%. FTIR and multivariable calibration methods accuracy was established by evaluating the root mean square error of prediction (RMSEP), the root mean square error of calibration (RMSEC) and the correlation coefficient (R2) and after cross-validation, cross validated error of calibration (RMSECV) and the correlation coefficient (R2) added as statistical evaluation parameters. Establishing the correct number of factors to be used in the correlation files allows calculating the predicted zeolite property values from the model using the number of factors used in the model. Too few factors will not adequately model the system, while too many factors will introduce noise vectors in the calibration. These noise vectors will result in less than optimum prediction for samples outside the calibration set. The Nicolet TQ Analyst program provides RMSECV data by plotting the predicted residual error sum of squares (PRESS, which is a factor analysis method) versus model factors (1-10) to select the appropriate factor. FIG. 6A is a graph 600a that shows calculated and actual silicon/aluminum ratios of zeolite after cross-validation. FIG. 6B is a graph 600b that shows the difference between calculated and actual silicon/aluminum ratios of zeolite after cross-validation. The plots 600a and 600b represent validation results for Si/Al ratio after cross-validation. The PLS method was found to have a high prediction ability for determining zeolite properties after cross validation (RMSECV=0.0557) and R² value with 5 factors for Si/Al ratio cross-validation was obtained as high as 1.00 as shown in FIGS. 6A and 6B.

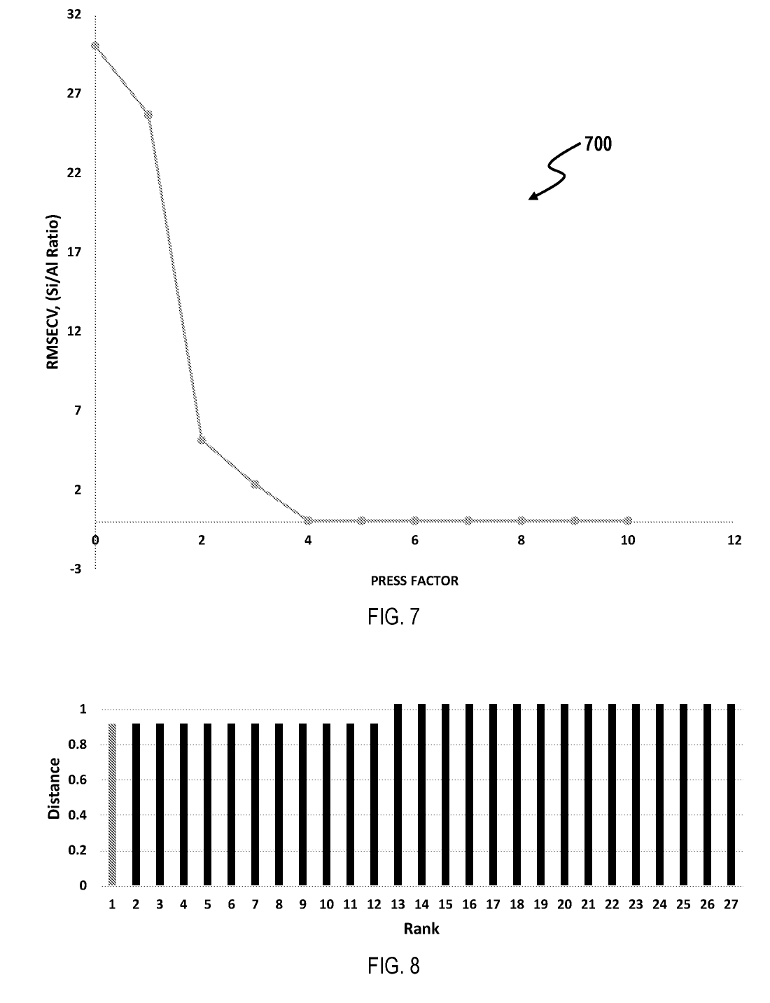

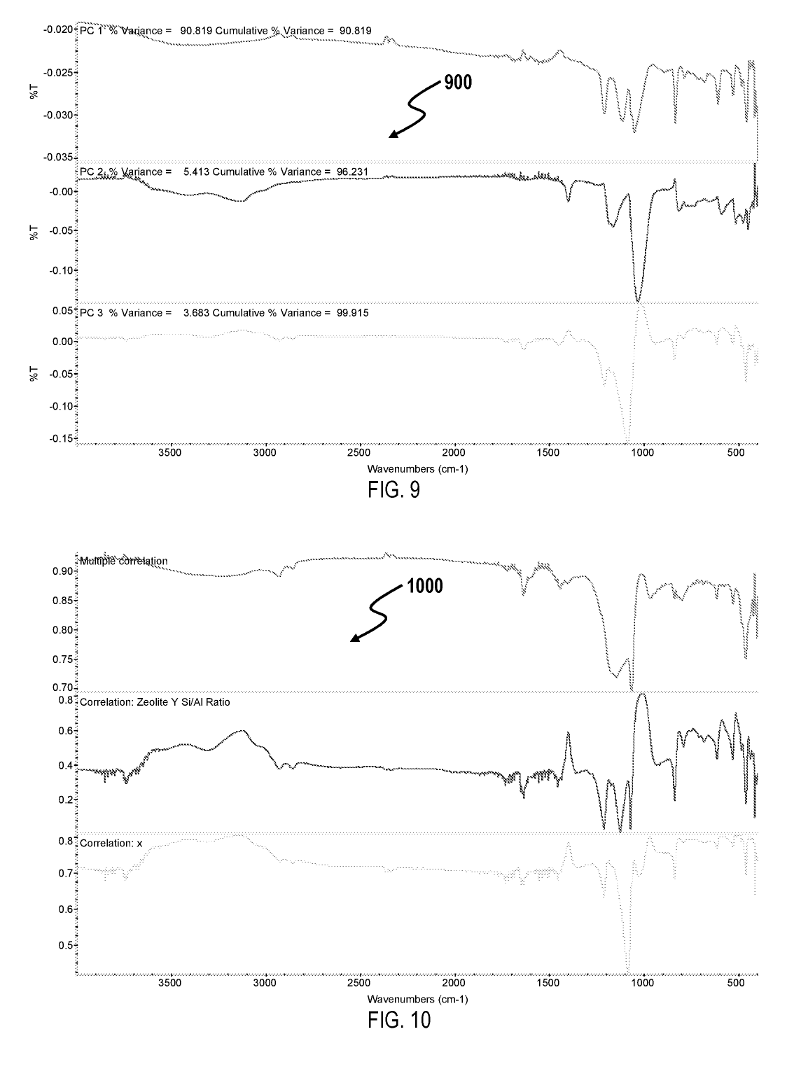

FIG. 7 is a graph 700 of lowest predicted residual sum of squares (PRESS) of the root mean square error of the calculated silicon/aluminum ratios from cross-validation. The optimum number of factors is important to avoid overfitting by using one-leave-out cross validation procedure when using PLS method. This procedure was repeated until each sample was left out once. FIG. 8 is a graph of outliers for the silicon/aluminum ratios of zeolite. The spectrum outlier attempts to isolate any standard sample that does not fit the model statistically by analyzing variation and reporting deviation from the mean spectrum. FIG. 9 is a graph 900 that shows the principle component spectra for the silicon/aluminum ratio of zeolite. FIG. 10 is a graph 1000 that shows the statistical spectra for the silicon/aluminum ratio of zeolite.

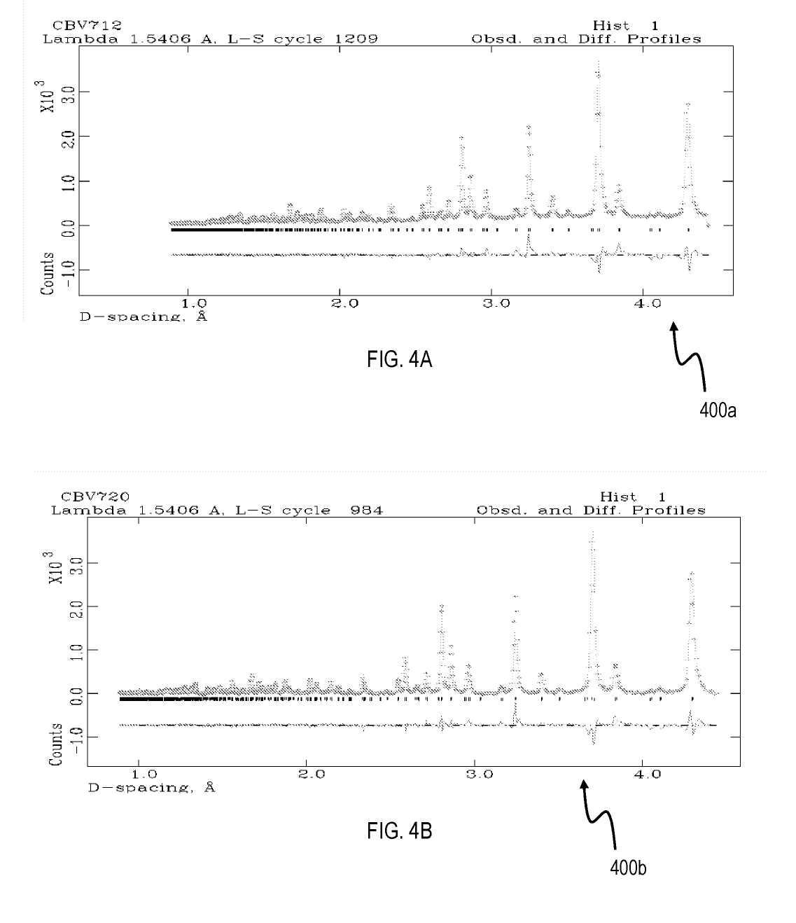

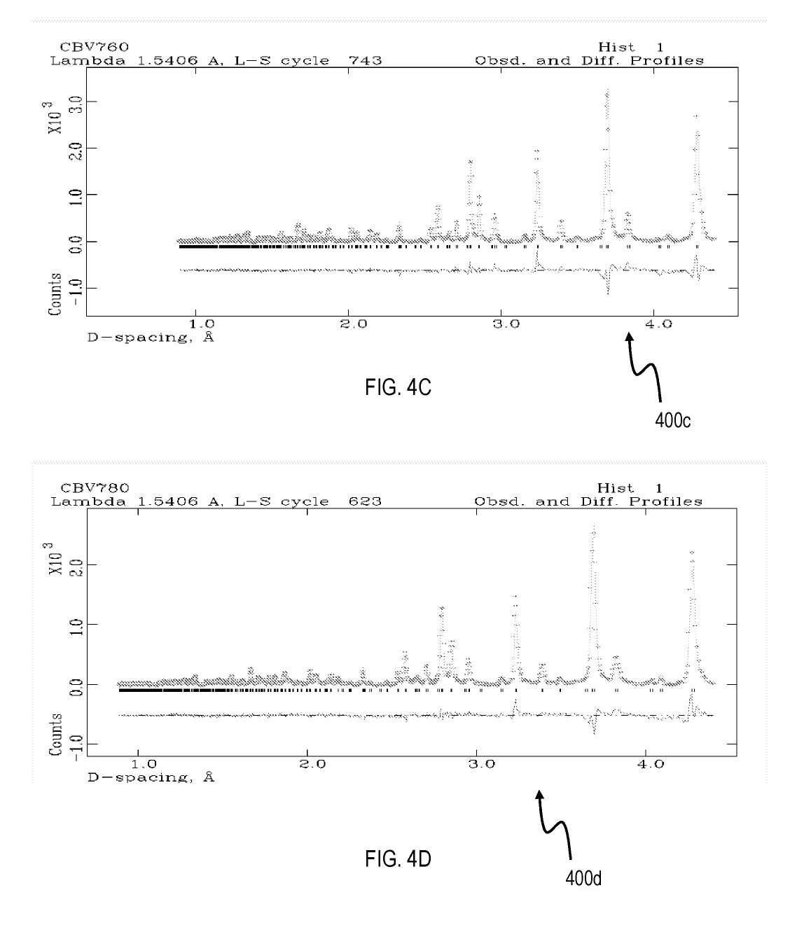

FIGS. 4A, 4B, 4C, and 4D are graphs 400a, 400b, 400c and 400d, respectively, that show calculated and measured X-Ray diffraction patterns of various zeolites. FIG. 4A is a comparison of the calculated and measured XRD patterns of CVB712 zeolite Y. FIG. 4B is a comparison of the calculated and measured XRD patterns of CVB720 zeolite Y. FIG. 4C is a comparison of the calculated and measured XRD patterns of CVB760 zeolite Y. FIG. 4D is a comparison of the calculated and measured XRD patterns of CVB780 zeolite Y. The refined structural parameters obtained from the Rietveld refinement with the March model for the crystallographic preferred orientation agreed well with the single-crystal XRD data results. Additionally, the calculated patterns agreed well with the measured XRD patterns for the all Y-zeolite catalysts. Therefore, the March is recommended for correction of the preferred orientation in XRD analysis for both crystal structure refinement and Si/Al ratio determination.

The obtained values from XRD also used as input values for the multivariate calibration with PLS in the FT-IR. Table 4 shows these values.

TABLE 4
Zeolite Y input values (standards)

| | | | | | | Weight | Weight | Unit | |
|---|---|---|---|---|---|---|---|---|---|
| | | Zeolite Y | | | | Loss | Loss | Cell | |
| | | Si/Al | | W_{DR} | W_{TOT} | @300° C. | @600° C. | Size | a |
| Index | Usage | Ratio | x | cm⁻¹ | cm⁻¹ | % | % | Angstr. | nm |
| 1 | Calibration | 12.00 | 0.077 | 608.30 | 1074.30 | 14.63 | 16.09 | 24.351 | 2.433706 |
| 2 | Calibration | 12.10 | 0.077 | 608.31 | 1074.31 | 14.63 | 16.10 | 24.353 | 2.433706 |
| 3 | Calibration | 12.11 | 0.077 | 608.32 | 1074.32 | 14.62 | 16.08 | 24.352 | 2.433706 |
| 4 | Calibration | 12.11 | 0.077 | 608.33 | 1074.33 | 14.60 | 16.05 | 24.350 | 2.433706 |
| 5 | Calibration | 12.10 | 0.077 | 608.30 | 1074.32 | 14.65 | 16.03 | 24.350 | 2.433706 |
| 6 | Calibration | 12.00 | 0.077 | 608.31 | 1074.35 | 14.63 | 16.09 | 24.355 | 2.433706 |
| 7 | Validation | 30.00 | 0.032 | 608.60 | 1075.40 | 12.54 | 13.71 | 24.280 | 2.431006 |
| 8 | Validation | 30.10 | 0.032 | 608.61 | 1075.41 | 12.53 | 13.70 | 24.281 | 2.431006 |
| 9 | Calibration | 30.12 | 0.032 | 608.62 | 1075.42 | 12.50 | 13.75 | 24.283 | 2.431006 |
| 10 | Calibration | 30.13 | 0.032 | 608.63 | 1075.42 | 12.50 | 13.68 | 24.280 | 2.431006 |
| 11 | Calibration | 30.13 | 0.032 | 608.60 | 1075.43 | 12.52 | 13.66 | 24.285 | 2.431006 |
| 12 | Calibration | 30.14 | 0.032 | 608.60 | 1075.40 | 12.50 | 13.70 | 24.280 | 2.431006 |
| 13 | Calibration | 60.00 | 0.016 | 611.10 | 1079.10 | 11.79 | 12.81 | 24.240 | 2.426673 |
| 14 | Validation | 60.00 | 0.016 | 611.10 | 1079.12 | 11.80 | 12.80 | 24.240 | 2.426673 |
| 15 | Calibration | 60.10 | 0.016 | 611.11 | 1079.13 | 11.83 | 12.78 | 24.243 | 2.426673 |
| 16 | Calibration | 60.12 | 0.016 | 611.12 | 1079.14 | 11.85 | 12.83 | 24.240 | 2.426673 |
| 17 | Calibration | 60.13 | 0.016 | 611.13 | 1079.13 | 11.80 | 12.80 | 24.245 | 2.426673 |
| 18 | Calibration | 60.00 | 0.016 | 611.10 | 1079.14 | 11.80 | 12.83 | 24.243 | 2.426673 |
| 19 | Calibration | 80.00 | 0.012 | 612.00 | 1081.70 | 10.38 | 11.48 | 24.241 | 2.422922 |
| 20 | Calibration | 80.10 | 0.012 | 612.00 | 1081.70 | 10.35 | 11.50 | 24.243 | 2.422922 |
| 21 | Validation | 80.11 | 0.012 | 612.00 | 1081.71 | 10.36 | 11.52 | 24.240 | 2.422922 |
| 22 | Calibration | 80.12 | 0.012 | 612.13 | 1081.72 | 10.38 | 11.50 | 24.244 | 2.422922 |
| 23 | Calibration | 80.00 | 0.012 | 612.10 | 1081.73 | 10.40 | 11.46 | 24.247 | 2.422922 |
| 24 | Calibration | 80.00 | 0.012 | 612.13 | 1081.74 | 10.42 | 11.48 | 24.240 | 2.422922 |
| 25 | Validation | 5.20 | 0.161 | 587.90 | 1051.70 | 20.73 | 23.30 | 24.530 | 2.435420 |
| 26 | Validation | 5.20 | 0.161 | 587.94 | 1051.71 | 20.75 | 23.33 | 24.531 | 2.435420 |
| 27 | Calibration | 5.21 | 0.161 | 587.91 | 1051.72 | 20.70 | 23.20 | 24.535 | 2.435420 |
| 28 | Calibration | 5.21 | 0.161 | 587.93 | 1051.73 | 20.78 | 23.25 | 24.531 | 2.435420 |
| 29 | Calibration | 5.20 | 0.161 | 587.90 | 1051.70 | 20.73 | 23.30 | 24.530 | 2.435420 |
| 30 | Calibration | 5.21 | 0.161 | 587.92 | 1051.75 | 20.74 | 23.34 | 24.533 | 2.435420 |
| 31 | Calibration | 12.00 | 0.077 | 608.30 | 1074.30 | 20.70 | 23.30 | 24.350 | 2.433706 |

Table 4 represents a calibration model that maps Si/Al ratios of simulated zeolite Y samples to the FT-IR spectra of those samples. Having developed the calibration model and validated the model using FT-IR spectra of actual zeolite Y samples (as described earlier), the calibration model can be used to determine, for example, predictively determine, the Si/Al ratio of a new zeolite Y sample by obtaining the FT-IR spectra of the new zeolite Y sample and identifying the Si/Al ratio from the calibration model that matches the FT-IR spectra of the new zeolite Y sample. The Si/Al ratio of the new zeolite sample can be determined with more accuracy compared to traditional techniques. Additional properties of the new zeolite sample, for example, any property important for catalyst characterizations, can also be determined either as a group or one property at a time as long as the unknown sample properties are within the chosen minimum to maximum range. In this manner, the Si/Al ratios of zeolite Y samples can be determined without using toxic chemicals and using very small amounts (for example, 1-2 mg) and in a short time.

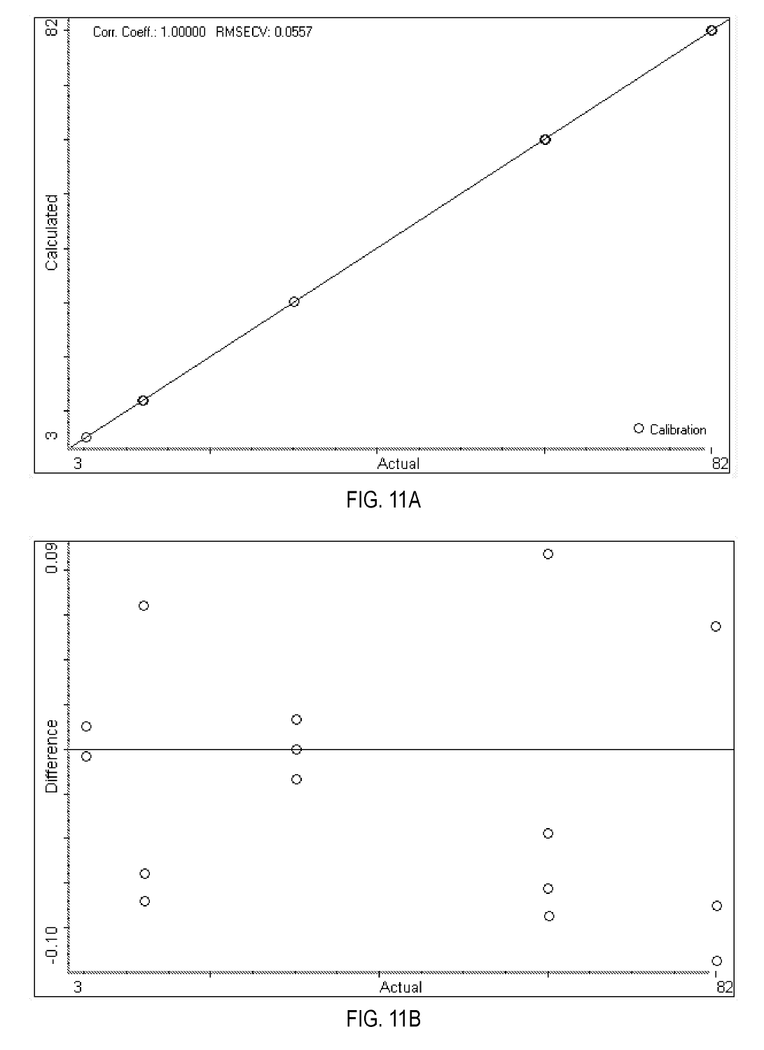

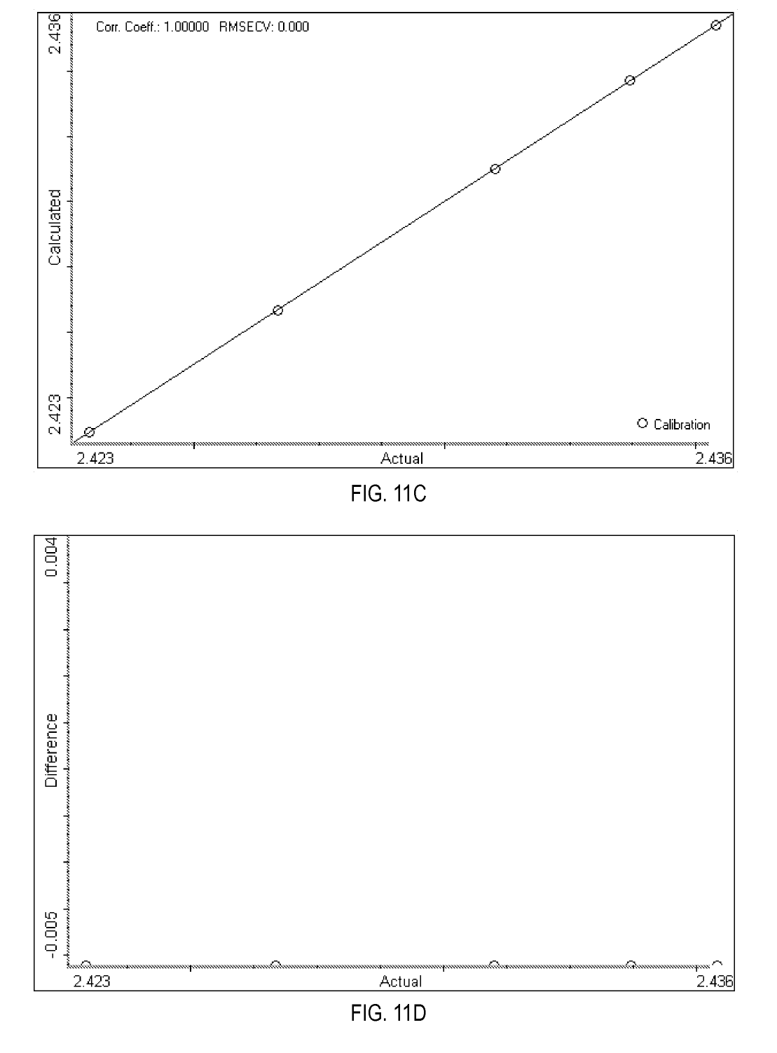

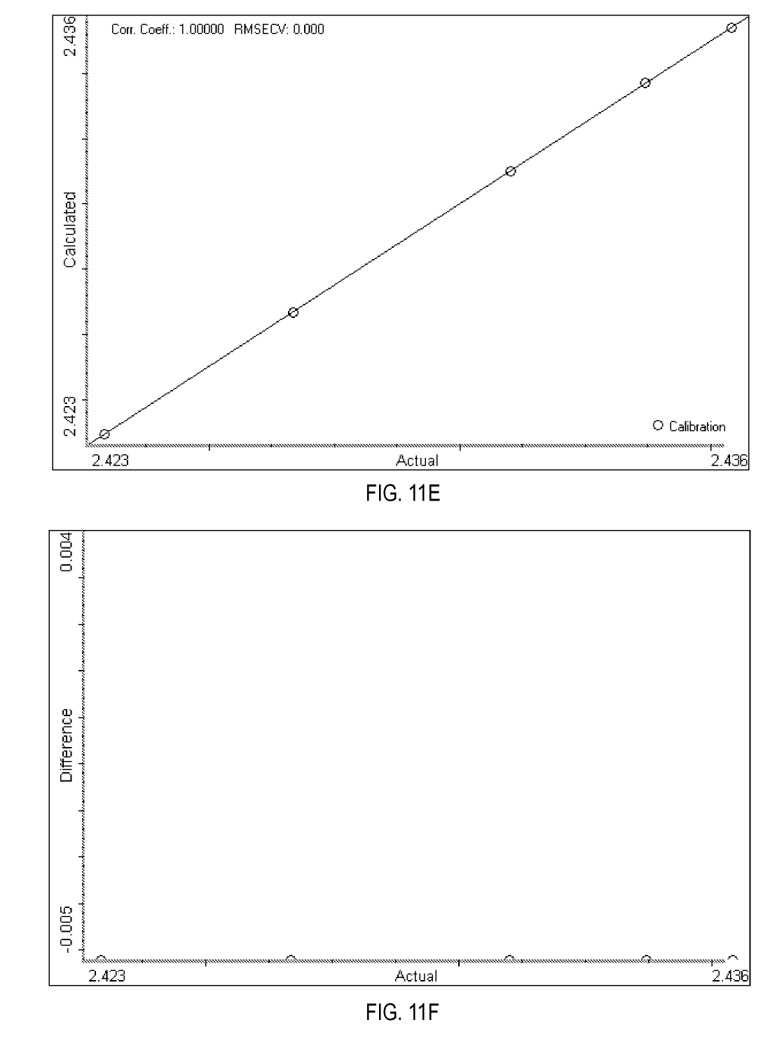

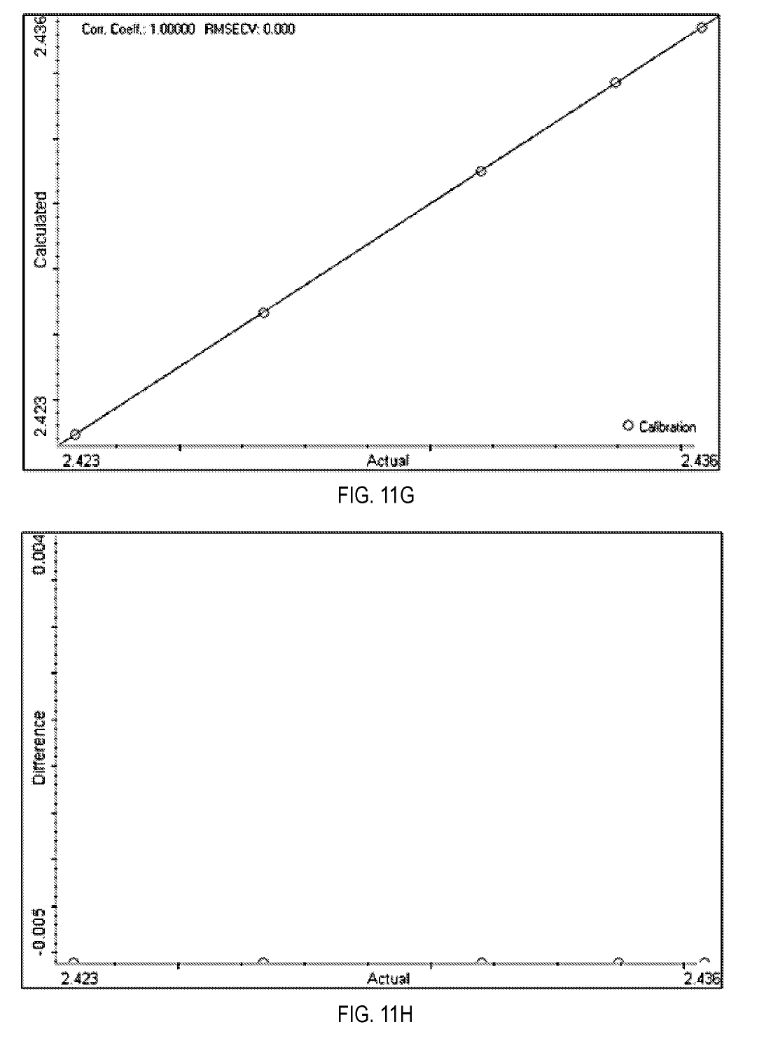

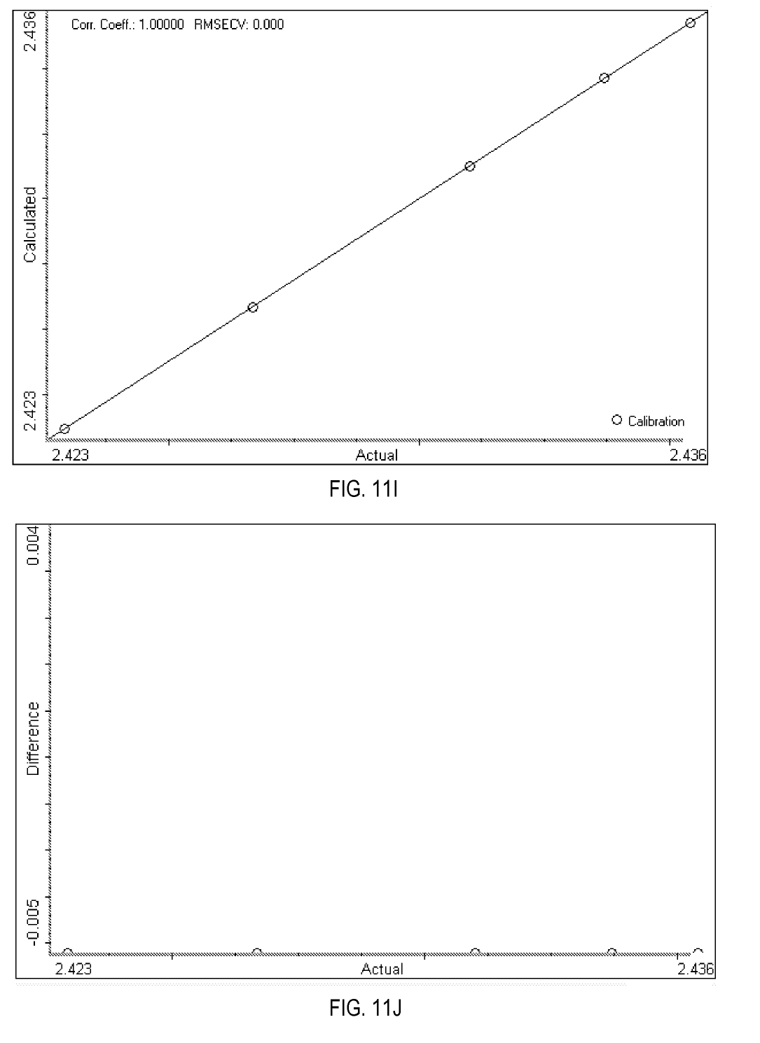

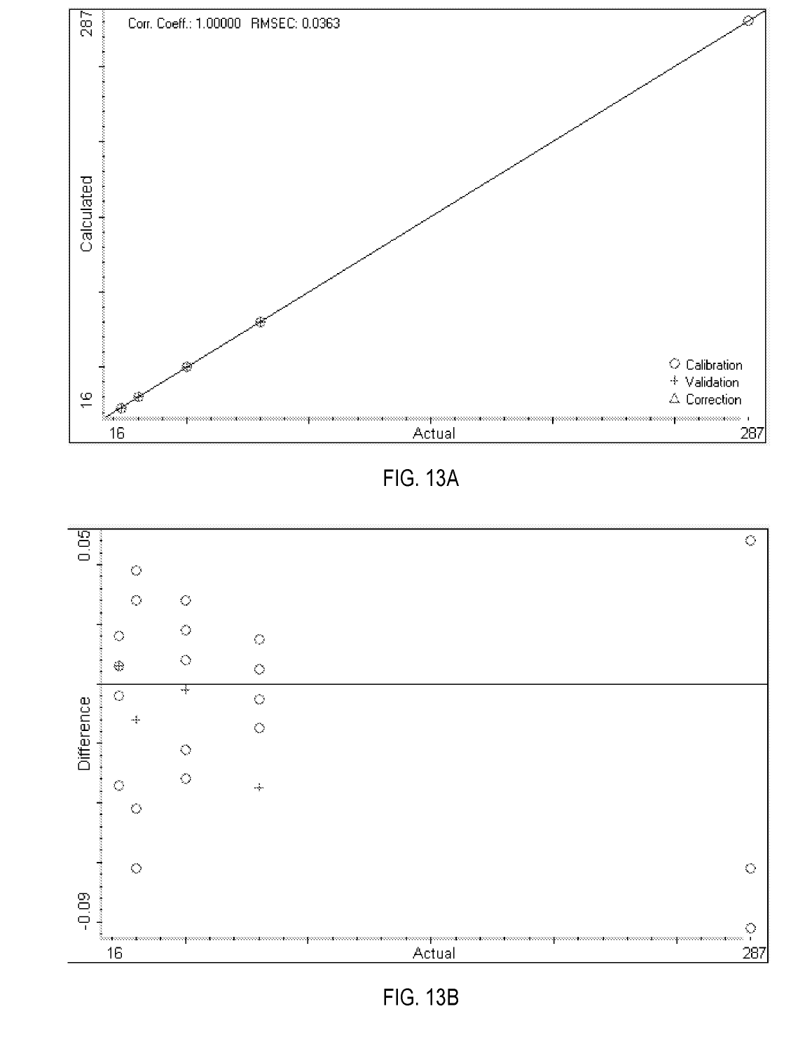

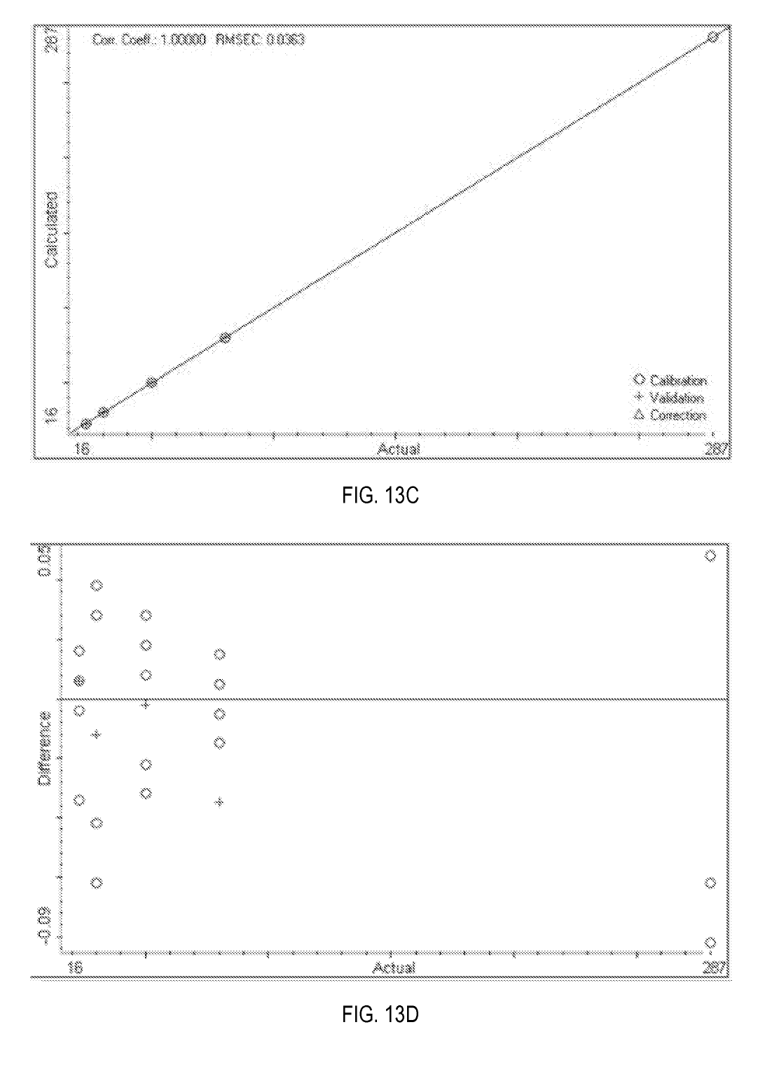

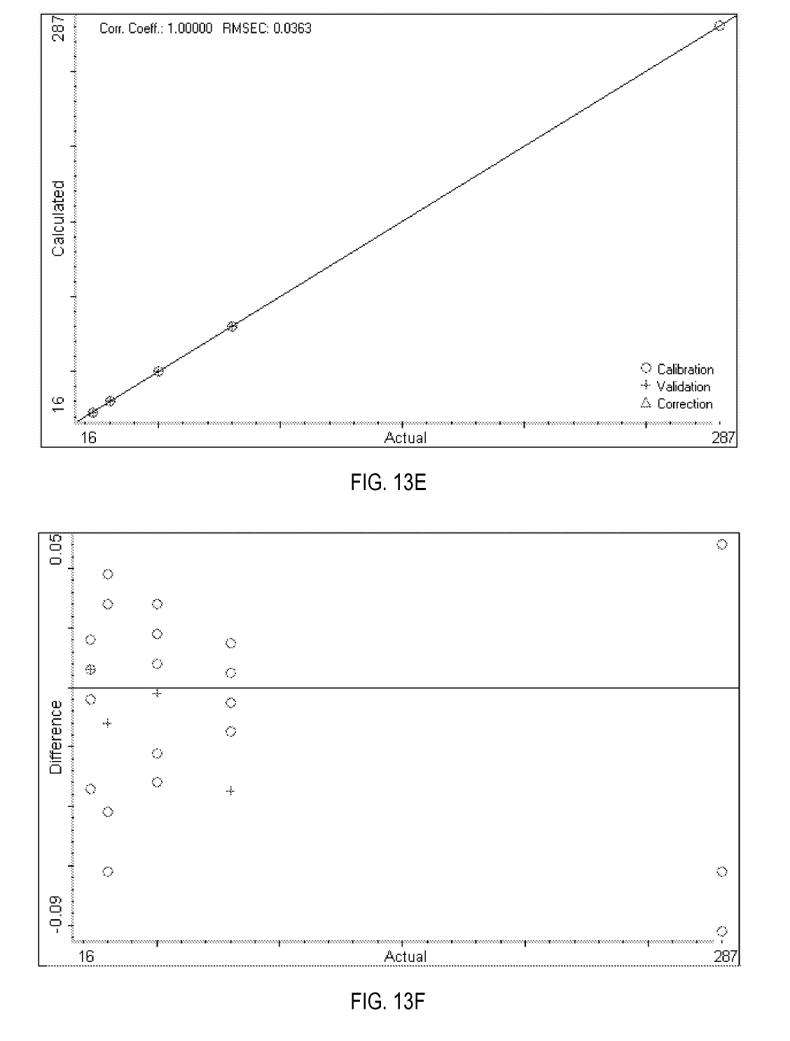

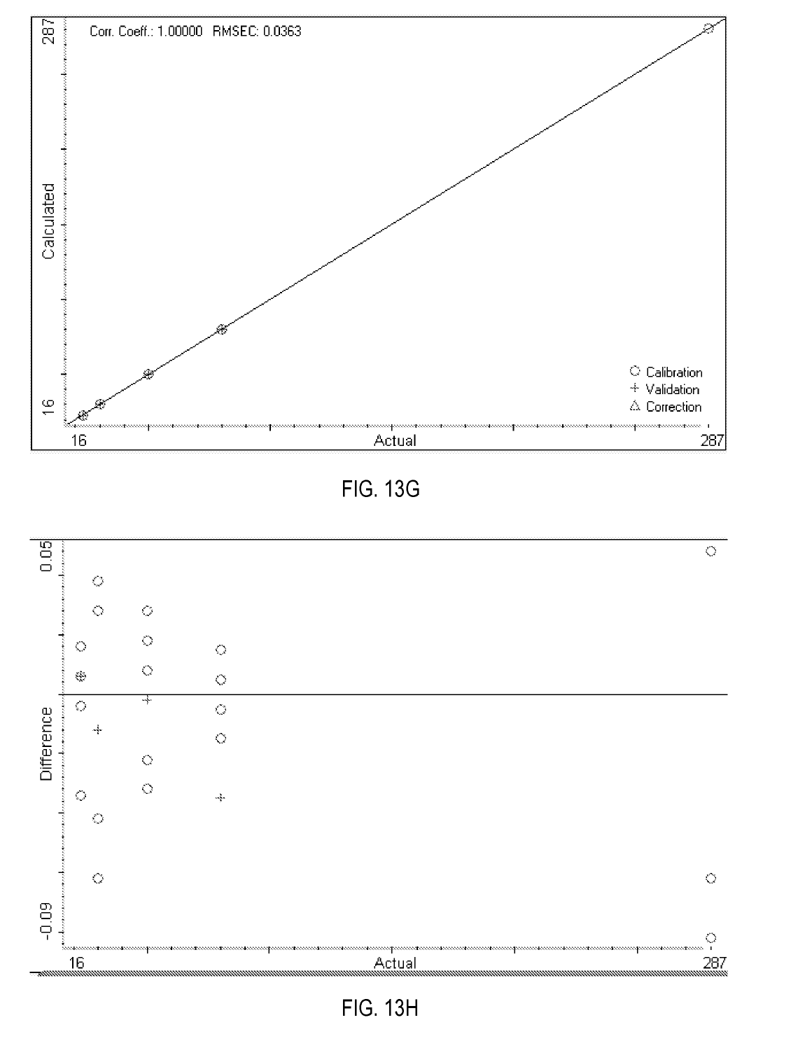

FIGS. 11A, 11B, 11C, 11D, 11E, 11F, 11G, 11H, 11I, and 11J are graphs that show quantification results of samples of zeolite with various silicon/aluminum ratios. FIG. 12 is a thermogram from thermogravimetric analysis (TGA) for various samples of zeolite. FIGS. 13A, 13B, 13C, 13D, 13E, 13F, 13G and 13H are graphs that show quantification results of samples of zeolite with various silicon/aluminum ratios.

Table 5 shows a summary of the Rietveld refinement results for the CBV500, CBV712, CBV720, CBV760 and CBV780 Y-zeolite catalysts obtained from Rietveld refinement with the March model. The space group used was Fd-3m (No. 227), and the cell formula unit is Z=1.

TABLE 5
Summary of Rietveld refinement results.

| | Results | | | | |
|---|---|---|---|---|---|
| Parameters | CBV500 | CBV712 | CBV720 | CBV760 | CBV780 |
| R_{P} | 15.91 | 9.69 | 10.14 | 9.97 | 9.26 |
| R_{WP} | 20.21 | 11.92 | 12.93 | 12.58 | 11.58 |
| R(F²) | 25.67 | 28.02 | 29.05 | 30.93 | 29.49 |
| χ² | 6.074 | 2.141 | 2.301 | 2.199 | 1.84 |
| r | 1.134 (5) | 1.128 (8) | 1.123 (7) | 1.126 (8) | 1.129 (2) |

Table 6 on the other hand shows TPD-NH₃ adsorption for ZSM-5 with different molar ratio of Si/Als obtained using FTIR chemometrics. When the weight of the samples used were either (1.00±0.05)g or (0.25±0.05)g in this study, the Si/Al ratio of the results for all the five zeolite-Y catalysts obtained from Wavelength Dispersive X-Ray Fluorescence (WDXRF) spectrometry agreed well with the literature values reported by Zeolyst (see Tables 7 and 8). This demonstrates that WDXRF technique is an effective method for field applications and for screening as high throughput analysis.

TABLE 6
TPD-NH₃ adsorption for ZSM-5 with different
molar ratio of Si/Al.

| | This Study |
|---|---|
| Sample | Total Acidity (mmole NH₃/g catalyst) |
| ZSM-5 (20) | 23.03 |
| ZSM-5 (23) | 20.69 |
| ZSM-5 (30) | 20.76 |
| ZSM-5 (40) | 19.93 |
| ZSM-5 (50) | 19.93 |
| ZSM-5 (80) | 19.93 |

Table 7 gives the summary of Si/Al ratio of “standard Zeolite-Y” result obtained from WDXRF spectroscopy when the weight of the sample was (1.00±0.05)g.

TABLE 7
Summary of Si/Al ratio of “standard Zeolite-Y” result
obtained from WDXRF spectroscopy when the weight of the
sample was (1.00 ± 0.05) g.

| | | | Weight | | | SiO₂/ |
|---|---|---|---|---|---|---|
| | | | Percentage | | | Al₂O₃ |
| | | | (wt %) | | | Mole |
| | Weight | | of the | | Result of | Ratio |
| | (grams) | | elements | | WDXRF | Reported |
| Description | Sample | binder | Si | Al | spectroscopy | by Zeolyst |
| CBV 500 | 0.9425 | 0.9089 | 25.62 | 9.22 | 5.55 | 5.2 |
| CBV 712 | 1.0020 | 0.9040 | 32.27 | 5.15 | 12.53 | 12 |
| CBV 720 | 1.0005 | 0.9018 | 33.72 | 2.41 | 28.04 | 30 |
| CBV 760 | 1.0013 | 0.9033 | 39.02 | 1.36 | 57.46 | 60 |
| CBV 780 | 1.0072 | 0.9070 | 38.14 | 0.83 | 92.19 | 80 |

Table 8 gives the summary of Si/Al ratio of “standard Zeolite-Y” result obtained from WDXRF spectroscopy when the weight of the sample was (0.25±0.05)g.

TABLE 8
Summary of Si/Al ratio of “standard Zeolite-Y” result
obtained from WDXRF spectroscopy when the weight of the
sample was (0.25 ± 0.05) g.

| | | | Weight | | | SiO₂/ |
|---|---|---|---|---|---|---|
| | | | Percentage | | | Al₂O₃ |
| | | | (wt %) | | | Mole |
| | Weight | | of the | | Result of | Ratio |
| | (grams) | | elements | | WDXRF | Reported |
| Description | Sample | binder | Si | Al | spectroscopy | by Zeolyst |
| CBV 500 | 0.2502 | 0.9027 | 25.65 | 9.23 | 5.55 | 5.2 |
| CBV 712 | 0.2561 | 0.9050 | 28.57 | 6.47 | 8.83 | 12 |
| CBV 720 | 0.2573 | 0.9078 | 35.67 | 2.26 | 31.66 | 30 |
| CBV 760 | 0.2550 | 0.9040 | 34.86 | 1.19 | 58.62 | 60 |
| CBV 780 | 0.2552 | 0.9070 | 37.19 | 0.77 | 97.20 | 80 |

In summary, this disclosure describes a fast, high throughput analysis (HTA) implementing FT-IR and chemometrics in association with statistical multi-variate analysis for determining Si/Al molar ratios and other properties of zeolite using a small quantity of sample (for example, less than 1 mg) without using any toxic chemicals. The techniques involve regression model building with cross validation based on data collected from laboratory analysis of zeolite samples with standard ASTM methods. These data are then used to generate a predictive data set, using which Si/Al ratio of unknown zeolite samples are obtained. The techniques use specified regions of the calibration spectra, the area of which varies statistically as a function of sample properties. By implementing the techniques described here, Si/Al ratios in the range of 3-1000 can be predicted by FT-IR spectral data. Alternatively, or in addition, near infrared (NIR) or X-Ray Fluorescence (XRF) can also be used.

Thus, particular implementations of the subject matter have been described. Certain aspects of the subject matter can be implemented using a computer system that includes one or more processors and a computer-readable medium storing instructions executable by the one or more processors to perform operations (for example, building and validating the calibration model) described here. In some implementations, the computer system can be a desktop computer, a laptop computer, a smart phone, a tablet computer, or can include multiple computers connected to one other across a network (for example, a distributed server system). Other implementations are within the scope of the following claims.

1. A method comprising:
determining Fourier Transform Infrared (FT-IR) spectra of a first physical zeolite Y sample;
determining a silicon-aluminum (Si/Al) ratio of the first physical zeolite Y sample;
generating, by one or more processors of a computer system, a computational zeolite Y sample having properties substantially similar to properties of the first physical zeolite Y sample, the computational zeolite Y sample associated with properties including a computational Si/Al ratio and computational FT-IR spectra;
generating, by the one or more processors, a calibration model that maps Si/Al ratio of the computational zeolite Y sample to FT-IR spectra of the computational zeolite Y sample based on the Si/Al ratio of the first physical zeolite Y sample and the FT-IR spectra of the first physical zeolite Y sample;
receiving a second physical zeolite Y sample different from the first physical zeolite Y sample;
determining FT-IR spectra of the second physical zeolite Y sample; and
determining a Si/Al ratio of the second physical zeolite Y sample using the calibration model and the FT-IR spectra of the second physical zeolite Y sample.

2. The method of claim 1, wherein the FT-IR spectra of the first physical zeolite Y sample is determined with a spectrophotometer with deuterated triglycine sulfate (DTGS) detector with an average of 128 scans at a resolution of 4 cm⁻¹.

3. The method of claim 1, wherein the Si/Al ratio of the first physical zeolite Y sample is determined by X-Ray Diffraction.

4. The method of claim 1, wherein generating the calibration model comprises:
determining statistical correlations between the FT-IR spectra and the Si/Al ratio of the first physical zeolite Y sample; and
associating the statistical correlations to the computational zeolite Y sample.

5. A method comprising:
determining Fourier Transform Infrared (FT-IR) spectra of each of a plurality of first physical zeolite samples;
determining a silicon-aluminum (Si/Al) ratio of each of the plurality of first physical zeolite samples;
generating, by one or more processors of a computer system, a calibration model that maps Si/Al ratio of a plurality of computational zeolite samples to FT-IR spectra of the plurality of computational zeolite samples;
validating, by the one or more processors, the calibration model using the FT-IR spectra of each of the plurality of first physical zeolite samples and the Si/Al ratio of each of the plurality of first physical zeolite samples;
receiving a second physical zeolite sample separate from the plurality of first physical zeolite samples;
determining FT-IR spectra of the second physical zeolite sample; and
determining a Si/Al ratio of the second physical zeolite sample using the calibration model and the FT-IR spectra of the second physical zeolite sample.

6. The method of claim 5, wherein each zeolite sample is a Faujasite-type zeolite sample.

7. The method of claim 5, wherein each zeolite sample is a zeolite Y sample.

8. The method of claim 5, wherein the FT-IR spectra of each physical zeolite sample is determined with a spectrophotometer with deuterated triglycine sulfate (DTGS) detector with an average of 128 scans at a resolution of 4 cm⁻¹.

9. The method of claim 5, wherein the Si/Al ratio of each physical zeolite sample is determined by a method approved by the American Society for Testing and Materials (ASTM).

10. The method of claim 9, wherein the method approved by the ASTM comprises X-Ray Diffraction.

11. A system comprising:
an X-Ray Diffraction instrument configured to determine a silicon-aluminum ratio in a zeolite sample;
a spectrophotometer configured to determine a Fourier Transform Infrared (FT-IR) spectra of the zeolite sample; and
a computer system comprising:
one or more processors; and
a computer-readable medium storing instructions executable by the one or more processors to perform operations comprising:
receiving FT-IR spectra of each of a plurality of first physical zeolite samples determined by the X-Ray Diffraction instrument;
receiving a silicon-aluminum (Si/Al) ratio of each of the plurality of first physical zeolite samples determined by the spectrophotometer;
generating a calibration model that maps Si/Al ratio of a plurality of computational zeolite samples to FT-IR spectra of the plurality of computational zeolite samples;
validating the calibration model using the FT-IR spectra of each of the plurality of first physical zeolite samples and the Si/Al ratio of each of the plurality of first physical zeolite samples; and
providing, as an output, the calibration model.

12. The system of claim 11, wherein the spectrophotometer is further configured to determine FT-IR spectra of a second physical zeolite sample separate from the plurality of first physical zeolite samples.

13. The system of claim 12, wherein the operations further comprise determining a Si/Al ratio of the second physical zeolite sample using the calibration model and the FT-IR spectra of the second physical zeolite sample.
